(19) United States
(12) Patent Application Publication
(10) Pub. No.: US 2006/0015827 A1
(43) Pub. Date: Jan. 19, 2006

(54) Method of implementing a screen saver on a peripheral LCD

(76) Inventors: Christa Ferguson, Round Rock, TX (US); Abizar Vakharia, Austin, TX (US)

Correspondence Address: HAMILTON & TERRILE, LLP, P.O. BOX 203518, AUSTIN, TX, 78720, US

(21) Appl. No.: 10/890,013

(22) Filed: Jul. 13, 2004

(51) Int. Cl. G06F 3/00

(52) U.S. Cl. 715/867

(57) ABSTRACT

A method for preserving a display device of a peripheral device which includes presenting peripheral information on the display device, determining whether a predetermined amount of time of inactivity elapses while the peripheral information is presented on the display device, presenting a screen saver when the predetermined amount of time has elapsed, determining whether a predetermined amount of screen saver time elapses while the screen saver is being presented, and blanking the display device if the predetermined amount of screen saver time elapses.

### BACKGROUND OF THE INVENTION

The present invention relates to the field of computer system peripherals and more particularly to computer system peripheral display devices.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Known peripheral devices include display devices integrated within the peripheral device. One issue relating to the display devices provided as part of the peripheral device relates to providing the display device with a screen saver. A screen saver is some form of moving presentation that ensures that a particular image does not permanently “burn in” to the screen of the display device. However, due in part to the limited lifetime of the display device, it is often not feasible to operate a screen saver all the time because operating the screen saver all of the time can cause the display device to fail sooner than desired.

Accordingly, it would be desirable to provide a peripheral device with a screen saver time limit.

### SUMMARY OF THE INVENTION

In accordance with the present invention, a peripheral device is provided which includes a display device having a time limited screen saver operation. Such a time limited screen saver module allows the display device to display information for a predetermined amount of time before blanking the screen. Such a time limit increases the life expectancy of the display device. Such a time limited screen saver also allows the screen saver to advertise ink sales.

In one embodiment, the invention relates to a method for preserving a display device of a peripheral device which includes presenting peripheral information on the display device, determining whether a predetermined amount of time of inactivity elapses while the peripheral information is presented on the display device, presenting a screen saver when the predetermined amount of time has elapsed, determining whether a predetermined amount of screen saver time elapses while the screen saver is being presented, and blanking the display device if the predetermined amount of screen saver time elapses.

In another embodiment, the invention relates to an apparatus for preserving a display device of a peripheral device which includes means for presenting peripheral information on the display device, means for determining whether a predetermined amount of time of inactivity elapses while the peripheral information is presented on the display device, means for presenting a screen saver when the predetermined amount of time has elapsed, means for determining whether a predetermined amount of screen saver time elapses while the screen saver is being presented, and means for blanking the display device if the predetermined amount of screen saver time elapses.

In another embodiment, the invention relates to an information handling system which includes a processor, memory coupled to the processor, a display device coupled to the processor and a screen saver module coupled to the display device. The screen saver modules includes a determining module, a presenting module, a screen saver determining module and a blanking module. The display device presents peripheral information. The determining module determines whether a predetermined amount of time of inactivity has elapsed while the peripheral information is presented on the display device. The presenting module presents a screen saver when the predetermined amount of time has elapsed. The screen saver determining module determines whether a predetermined amount of screen saver time has elapsed while the screen saver is being presented. The blanking module blanks the display device if the predetermined amount of screen saver time elapses.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer is used.

FIG. 2 shows a flow chart of the operation of a screen saver module.

FIG. 3 shows an example of a screen saver display device presentation.

### DETAILED DESCRIPTION

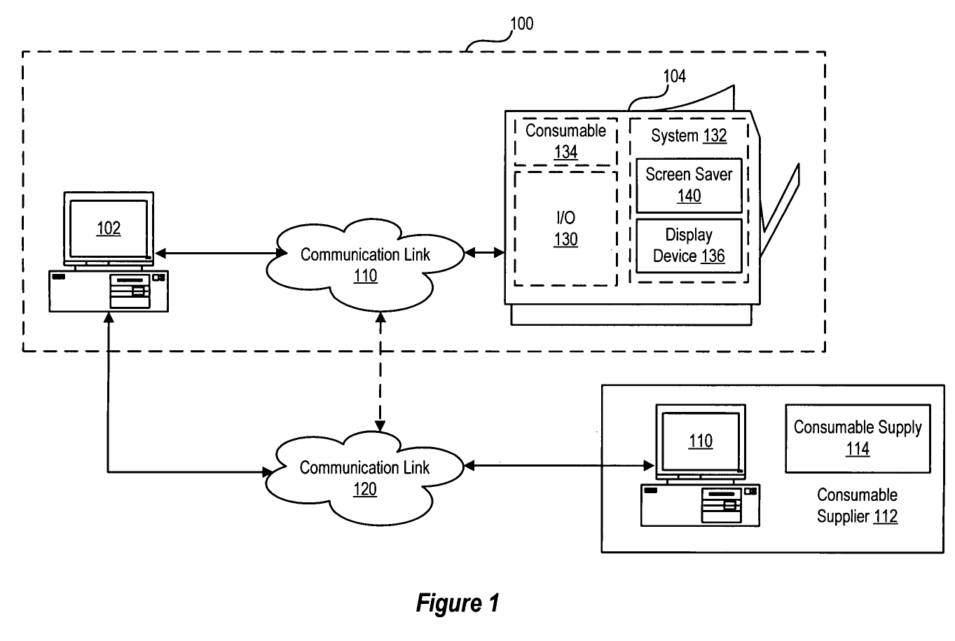

Referring to FIG. 1, a block diagram of an environment in which a printer is used is shown. The environment includes a computer system 102 and a printer 104, coupled via a communication link 110. The communication link 110 might be a printer cable, a network connection or any other link which information is communicated with the printer 104.

The computer system 102 is also connected to another computer system (e.g., a vendor computer system) 110 via a second communication link 120. The second communication link 120 may be a telephone system or some other type of network, such as the Internet. In one embodiment, computer system 110 is owned and operated by a printer consumable supplier 112. In this example, the printer consumable supplier 112 provides printer consumables for use with the printer 104 from a supply 114 of printer consumables. The printer 104 may be directly coupled to the second communication link 120, in which case communication may occur between the printer and anything coupled to the second communication link 120.

The printer 104 includes an input output (I/O) port 130, a control system 132, at least one printer consumable 134 and a display device 136. The I/O port 130 facilitates communications between the printer 104 and other devices connected to the communications link 110. The control system 132 provides the printer 104 with certain control functionality. The control system 132 includes a processor and memory coupled to the processor. The control system 132 includes a screen saver module 140, the screen saver module controls presenting a screen saver on the display device 136. A screen saver module 140 may be stored on either the memory of the printer 104 or within the memory of the computer system 102. The control system 132 may also include a print cartridge ordering system. The print cartridge ordering system may be stored on either the memory of the printer or within the memory of the computer system 102. In one embodiment the display device 136 is a liquid crystal display (LCD) type of device.

The printer consumable 134 represents any component in the printer 104 that is subject to depletion through use of the printer 104. For example, the printer consumable 134 may be a toner cartridge or an inkjet cartridge, etc. The printer consumable supplier maintains a supply 114 of replacement printer consumables 134.

The computer system 102 generates a document in an electronic form and transmits the document (in the form of a print job) to the printer 104. The printer 104 receives the print job via the I/O port 130 and prints the document. Each time the printer 104 prints a document, the printer 104 transmits a pre-defined message to the computer 102.

It may be determined that the consumable 134 should be replaced when certain criteria are met. For example, it is assumed that the consumable 134 should be replaced each time the printer 104 prints “n” pages. When this event occurs, the control system 132 sets a consumable replacement indicator.

The status of the consumable replacement indicator may be determined by the computer 102. This is accomplished by the computer 102 transmitting a pre-defined query to the printer 104. The printer 104 responds to the query by generating a response indicating whether the consumable replacement indicator is set.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. An information handling system may also be a printer. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

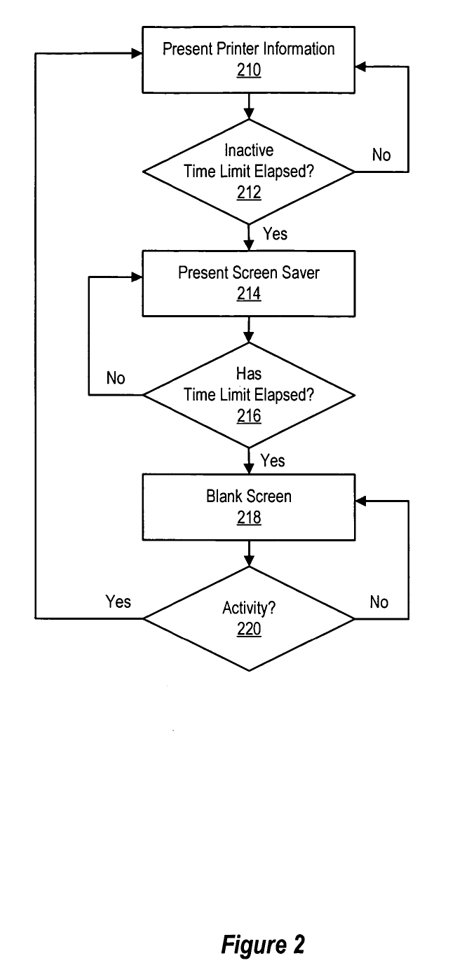

Referring to FIG. 2, a flow chart of the operation of a screen saver module is shown. More specifically, when the printer 104 is powered on, or when the printer returns from a power saving mode of operation, the display device 136 presents printer information at step 210. The printer information may include, for example, the type of operation that the printer is performing. The screen saver module 140 then determines whether a predetermined time limit has elapsed at step 212. If a predetermined time limit has not elapsed, then the display device 136 continues to present the printer information.

If the predetermined time lime has elapsed, then the screen saver module 140 causes the display device to present a screen saver at step 214. The screen saver may be, for example, an informational presentation regarding printer consumable consumption (e.g., a presentation of ink levels) as well as how to reorder consumables for the printer. The screen saver module 140 then determines whether a predetermined time limit has elapsed at step 216. If a predetermined time limit has not elapsed, then the display device continues to present the screen saver information.

If the predetermined time limit has elapsed, then the screen saver module 140 blanks the screen presentation at step 218. The screen saver module 140 continues to monitor whether any activity occurs within the printer at step 220. If no activity has occurred, then the screen saver module 140 continues to blank the screen. If the screen saver module 140 detects printer activity, then the screen saver module 140 presents printer information at step 210.

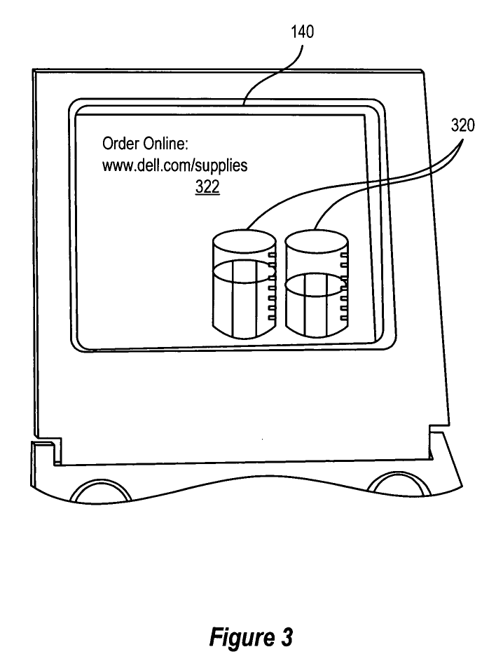

FIG. 3 shows an example of a screen saver presentation. More specifically, the screen saver presentation includes a consumable consumption indication 320. The consumable consumption indication 320 may correspond to each consumable within the printer 104. So for example, if the printer includes two types of ink, then the screen saver presentation would include two consumable consumption indications. The screen saver presentation also includes consumable replacement information 322.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while a particular printer architecture is set forth, it will be appreciated that variations within the printer architecture are within the scope of the present invention.

Also for example, the printer, including the screen saver and display device, may be included within a multifunction device.

Also for example, the screen saver can be used to present other types of information such as other types of advertising if desired.

Also for example, the above-discussed embodiments include modules and units that perform certain tasks. The modules and units discussed herein may include hardware modules or software modules. The hardware modules may be implemented within custom circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules and units is for illustrative purposes. Alternative embodiments may merge the functionality of multiple modules or units into a single module or unit or may impose an alternate decomposition of functionality of modules or units. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for preserving a display device of a peripheral device comprising:
presenting peripheral information on the display device;
determining whether a predetermined amount of time of inactivity elapses while the peripheral information is presented on the display device;
presenting a screen saver when the predetermined amount of time has elapsed;
determining whether a predetermined amount of screen saver time elapses while the screen saver is being presented; and,
blanking the display device if the predetermined amount of screen saver time elapses.

2. The method of claim 1 further comprising:
determining whether activity occurs within the peripheral device when the display device presentation is blanked; and,
presenting peripheral information on the display device when activity occurs within the peripheral device.

3. The method of claim 1 wherein:
the screen saver includes consumable consumption information.

4. The method of claim 1 wherein:
the screen saver includes consumable replacement instructional information.

5. The method of claim 1 wherein:
the screen saver includes advertising information.

6. The method of claim 1 wherein:
the peripheral device includes a printer.

7. The method of claim 1 wherein:
the display device includes an liquid crystal display (LCD) type screen.

8. An apparatus for preserving a display device of a peripheral device comprising:
means for presenting peripheral information on the display device;
means for determining whether a predetermined amount of time of inactivity elapses while the peripheral information is presented on the display device;
means for presenting a screen saver when the predetermined amount of time has elapsed;
means for determining whether a predetermined amount of screen saver time elapses while the screen saver is being presented; and,
means for blanking the display device if the predetermined amount of screen saver time elapses.

9. The apparatus of claim 8 further comprising:
means for determining whether activity occurs within the peripheral device when the display device presentation is blanked; and,
means for presenting peripheral information on the display device when activity occurs within the peripheral device.

10. The apparatus of claim 8 wherein:
the screen saver includes consumable consumption information.

11. The method of claim 8 wherein:
the screen saver includes consumable replacement instructional information.

12. The apparatus of claim 8 wherein:
the screen saver includes advertising information.

13. The apparatus of claim 8 wherein:
the peripheral device includes a printer.

14. The apparatus of claim 8 wherein:
the display device includes an liquid crystal display (LCD) type screen.

15. An information handling system comprising a processor;
memory coupled to the processor;
a display device coupled to the processor, the display devcie presenting peripheral information;
a screen saver module coupled to the display device, the screen saver module including:
a determining module, the determining module determining whether a predetermined amount of time of inactivity has elapsed while the peripheral information is presented on the display device;
a presenting module, the presenting module presenting a screen saver when the predetermined amount of time has elapsed;
a screen saver determining module, the screen saver determining module determining whether a predetermined amount of screen saver time has elapsed while the screen saver is being presented; and,
a blanking module, the blanking module blanking the display device if the predetermined amount of screen saver time elapses.

16. The information handling system of claim 15 wherein the screen saver module further includes:
an activity determining module, the activity determining module determining whether activity occurs within the peripheral device when the display device presentation is blanked; and,
a peripheral presenting module, the peripheral presenting module presenting peripheral information on the display device when activity occurs within the peripheral device.

17. The information handling system of claim 15 wherein:
the screen saver includes consumable consumption information.

18. The information handling system of claim 15 wherein:
the screen saver includes consumable replacement instructional information.

19. The information handling system of claim 15 wherein:
the screen saver includes advertising information.

20. The information handling system of claim 15 wherein:
the information handling system includes a printer.

21. The information handling system of claim 15 wherein:
the display device includes an liquid crystal display (LCD) type screen.
